(19) United States
(12) Patent Application Publication
(10) Pub. No.: US 2015/0260544 A1
(43) Pub. Date: Sep. 17, 2015

(54) METHOD FOR CALIBRATING THE PHYSICAL POSITION AND ORIENTATION OF AN ELECTRONIC DEVICE USING DEVICE SENSORS

(71) Applicant: IMSI DESIGN, LLC, Novato, CA (US)

(72) Inventors: Douglas R. Cochran, Novato, CA (US); Kevan Chapman, Novato, CA (US); Robert Mayer, Novato, CA (US); Royal Farros, Novato, CA (US)

(21) Appl. No.: 14/435,449

(22) PCT Filed: Oct. 11, 2013
(86) PCT No.: PCT/US13/64704

§ 371 Date: Apr. 13, 2015

Related U.S. Application Data
(60) Provisional application No. 61/712,744, filed on Oct. 11, 2012.

(51) Int. Cl. G01C 25/00; G01B 21/00

(52) U.S. Cl. CPC G01C 25/00; G01B 21/00

(57) ABSTRACT

A system for calibrating physical position and orientation of an electronic device, including an electronic data device with core processor, permanent memory for storing a program, temporary memory for running a program, an electronic visual display, a display subsystem, a user input device, a motion detection subsystem, and an orientation detection subsystem; and a program with instructions that, when executed by the core processor, cause the electronic data device to visually display a two- or three-dimensional virtual representation of a user-selected physical space on the electronic visual display and to display a prompt for a user to mark initial calibration points in the displayed virtual representation of the physical space, wherein after a user marks at least one calibration point, the program causes the electronic data device to adjust and update the location and orientation of the electronic data device as it is moved within the physical space.

### BACKGROUND OF THE INVENTION

1. Technical Field

The present invention relates to a method of calibrating a physical position in a 2D or 3D spatial representation on electronic device using device sensors.

2. Background Art

It is helpful to display a physical position calibrated in a 2D or 3D spatial representation on an electronic device when data from other forms of electronic positioning, such as but not limited to GPS (Global Positioning System), A-GPS (Assisted Global Positioning System), and WPS (Wi-Fi Positioning System), are not available. As an example: when performing an indoor building inspection at a remote location, it is helpful to have the inspector's current location and orientation accurately indicated on an electronic drawing. However, because GPS signals are blocked by buildings, terrain, and even dense foliage, satellite GPS does not work indoors, and if a building is too remote, cellular and Wi-Fi data may not be available. Data from an electronic device's sensors, including but not limited to accelerometers, gyroscopes, compass, and/or motion sensors, and/or the ability to manually fine-tune a position and/or orientation, combined with an electronic display, now make it possible to perform such positional calibration without assistance from other forms of electronic positioning systems.

### DISCLOSURE OF INVENTION

The present invention is a software-mediated and computer-implemented system and method for indicating an electronic device's current physical position and/or orientation on the display of an electronic device without assistance from GPS, A-GPS, WPS, or other forms of electronic positioning systems. The system includes a computer-executable program operated on an electronic device with a visual display showing a visual representation of the physical space. In use, the user selects reference location(s) (calibration points) in the visually displayed virtual physical space that correspond to physical locations in the actual physical space. From these initially selected calibration points, the device will gather positional data from device sensors as the device is moved to each reference location. The data is used to determine the position and/or orientation of the device in a 2D or 3D spatial representation on the device display. The position indicator may also be manually dragged by the user on the device display to fine-tune the indicated location, and with that data the system mathematically calculates and stores an offset.

The system may be employed to geolocate a previously non-geolocated document or it may be included as an element or part of a larger program or suite of programs with further features and functions.

Other novel features which are characteristic of the invention, as to organization and method of operation, together with further objects and advantages thereof will be better understood from the following description considered in connection with the accompanying drawings, in which preferred embodiments of the invention are illustrated by way of example. The drawings are for illustration and description purposes only and are not intended as a definition of the limits of the invention. The various features of novelty which characterize the invention are pointed out with particularity in the claims annexed to and forming part of this disclosure. The invention resides not in any one of these features taken alone, but rather in the particular combination of all of its structures for the functions specified.

### BRIEF DESCRIPTION OF THE DRAWINGS

The invention will be better understood and its various objects and advantages, other than those mentioned above, will be apparent when consideration is given to the following detailed description thereof. Such description makes reference to the annexed drawings wherein:

FIG. 1 is a block diagrammatic flow diagram showing the operational elements of an electronic device for operating the system of the present invention;

FIG. 2 is one of many possible schematic examples of a display on the type of electronic device in FIG. 1 showing a representation of a physical space that, in this situation, includes two calibration points;

FIG. 3 is schematic example showing the same display after calibration is complete, with a sample representation of one of many ways to depict current device position and/or orientation on the display; and

FIG. 4 is a flow chart showing the method steps involved in a sample use of the inventive system.

### BEST MODE FOR CARRYING OUT THE INVENTION

The present invention is a software-mediated, computer-implemented method for indicating an electronic device's current physical position and/or orientation on the display of an electronic device without assistance from other forms of electronic positioning systems. The invention includes an application (program) operated on the electronic device. The application includes means to display a representation of the physical space, to select reference location(s) in the physical space, to match the selected references to corresponding locations on the representative display, to gather positional data from the device sensors as the device is moved to each reference location, to use this data to determine the position and/or orientation of the device in the 2D or 3D spatial representation on the device display, to optionally drag the position indicator to fine-tune the location, and to mathematically calculate and store the offset. The application may or may not be used to geolocate a non-geolocated document or be included as part of a larger program or suite of programs that contain additional features beyond those described.

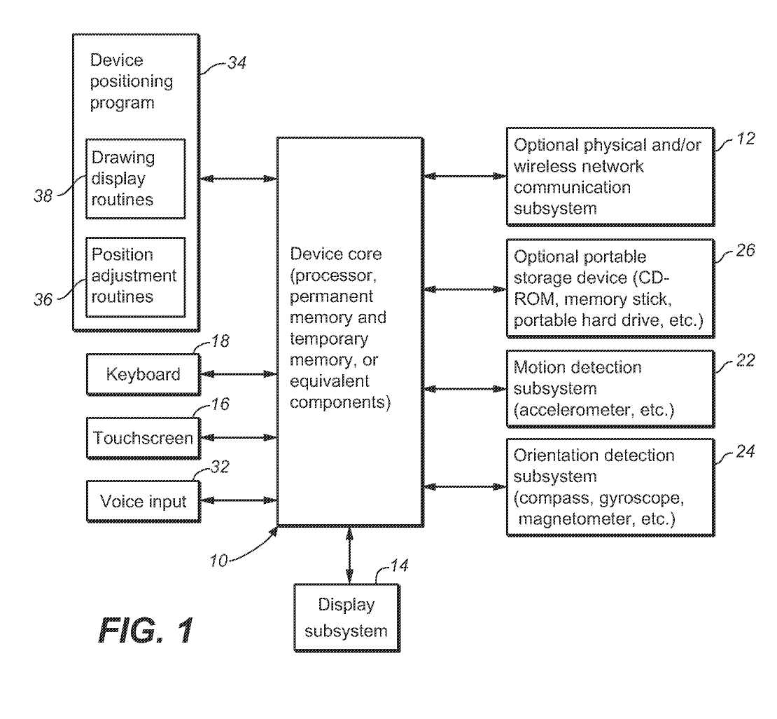

Referring to FIGS. 1 through 3, wherein like reference numerals refer to like components in the various views, FIG. 1 is a block diagram illustrating an embodiment of an electronic data device suitable for use in the present invention. The device may have a variety of features and inputs, but essential components include at least a core processor, permanent memory for storing a program in a computer-readable medium, and computer-readable temporary memory or functional equivalents for loading and running a program, collectively indicated by reference number 10 in FIG. 1; a means to load a computer-executable program onto the device, possibly using a physical or wireless network communications subsystem 12 or some form of removable computer-readable media 26, such as a CD-ROM, memory stick, portable hard drive, or the like; a display subsystem 14; a touchscreen 16, a keyboard 18, a voice input 32, or any of a number of other means of interacting with the program; a motion detection subsystem 22 including one or more motion detection sensors such as, but not limited to, a pedometer, accelerometer, magnetometer, and/or other means of detecting the device's physical movement; and an orientation detection subsystem 24 having one or more orientation detection sensors such as, but not limited to, a compass, gyroscope, magnetometer, and/or other means of determining the device's orientation 24. A computer-executable device positioning program 34 is loaded and executed on the electronic data device, and the user interface and program output is presented on the display subsystem 14.

There are many ways to use the inventive system. As an example, the electronic device 10 may be taken to a physical space (a location in or around a building or a defined outside space) where the program 34 is loaded or initiated. When the device positioning and orientation program is loaded, drawing display routines 38 are executed to provide a spatial representation of a selected physical space or structure, and the selection is then displayed by the display system 14. The calibration (position adjustment) routine 36 begins and may prompt the user to move the device to one or more locations in the physical space and to electronically mark those locations on the displayed spatial representation.

The program includes, as noted, one or more drawing display routines 38 which utilize the display subsystem 14.

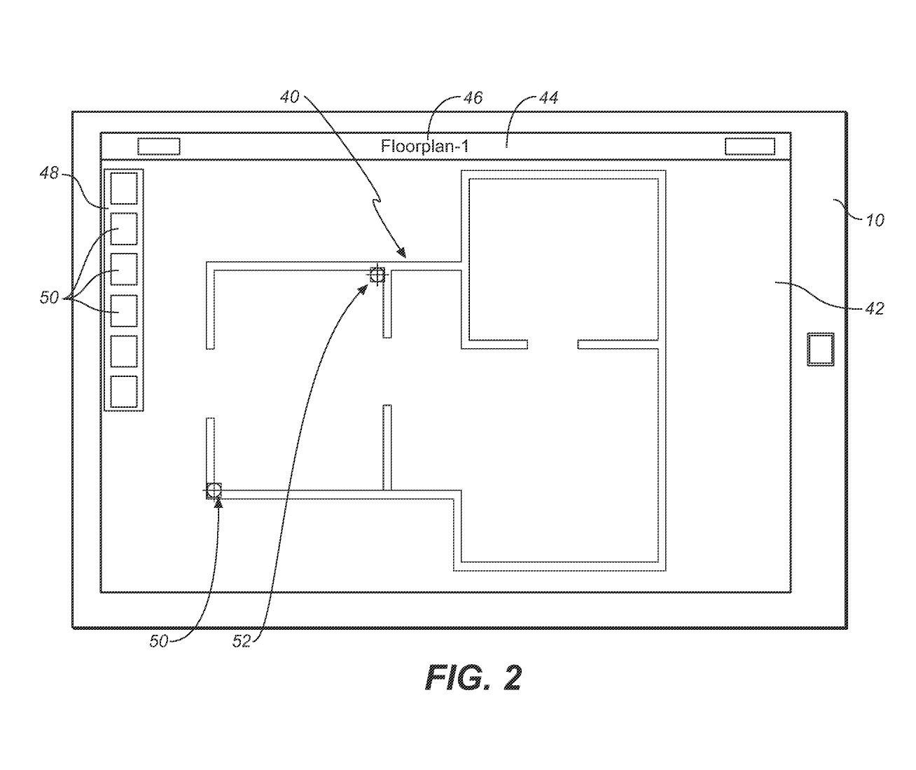

FIG. 2 shows the electronic device 10, with a sample drawing plan 40 shown on the device display surface 42. Optional title bar 44 shows the drawing name 46. A sample representation of a typical user interface bar 48 provides a means of initiating program commands 50. Two calibration points 52 and 54 are shown as already marked. In this situation, after the calibration points have been set, the program calculates a corresponding motion transformation function. As the user moves the device within the physical space, this transformation function, in conjunction with motion and/or orientation data from the device motion and orientation sensors, is used to calculate the device's updated location in the 2D or 3D spatial representation in either real time or time-delayed time, thus calibrating the device's actual physical position and/or orientation in the physical space to an equivalent location on the displayed representation.

Optionally the displayed position and/or orientation can be manually fine-tuned and recalibrated as well by simply dragging the sample position indicator to the desired location and/or orientation on the displayed representation. Note that the fine-tuned position and/or orientation will result in a positional and/or rotational offset that is calculated and stored and may be selectively used in future position determinations.

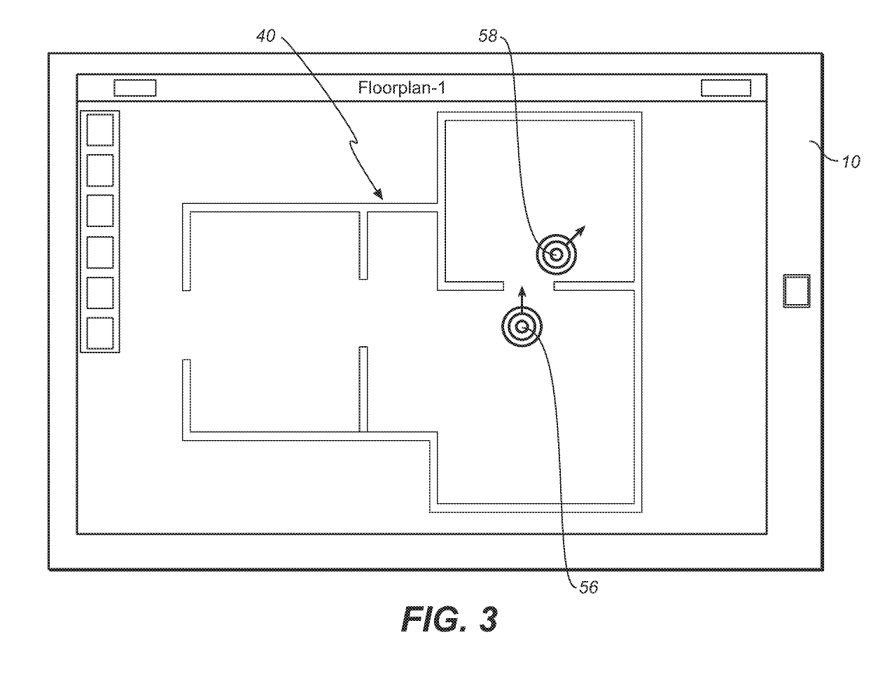

FIG. 3 shows the same device 10 and electronic drawing plan 40 after position and orientation calibrations have been completed. The device's current physical location and orientation within the physical space are shown on the displayed representation by sample position indicator 56. When the electronic device is physically moved, the program will change the position and/or orientation of the sample indicator 58 on the displayed representation to show the device's new location and heading direction in the physical space.

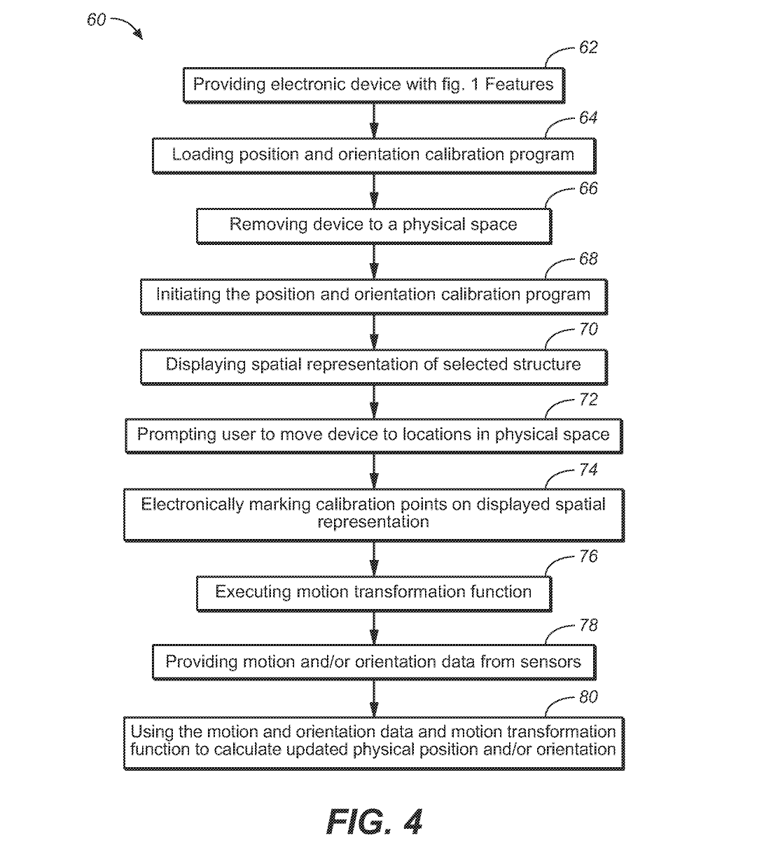

Referring next to FIG. 4, there is shown the method steps 60 for operating the inventive system. The steps include: providing an electronic device as described above 62, loading the above-described position and orientation calibration program on the electronic device 64, removing the electronic device to a physical space 66, initiating the position and orientation calibration program 68, displaying a spatial representation of a selected structure 70, prompting the user to move the electronic device to one or more locations in the physical space 72, electronically marking the selected locations on the displayed spatial representation to function as calibration points 74, executing a motion transformation (or coordinates and heading transformation) function 76, providing motion and/or orientation data from the electronic device motion and orientation sensors 78, using the motion and orientation data from the motion and orientation sensors in conjunction with the motion transformation function to calculate an updated physical position and/or orientation in the 2D or 3D spatial representation 80 on the electronic device display.

The foregoing disclosure is sufficient to enable those with skill in the relevant art to practice the invention without undue experimentation. The disclosure further provides the best mode of practicing the invention now contemplated by the inventors.

While the particular system and method herein shown and disclosed in detail is fully capable of attaining the many objects and providing the advantages described herein, it is to be understood that it is merely illustrative of the presently preferred embodiment of the invention and that no limitations are intended to the detail of construction or design herein shown other than as defined in the appended claims. Accordingly, the proper scope of the present invention should be determined only by the broadest interpretation of the appended claims so as to encompass all such modifications as well as all relationships equivalent to those illustrated in the drawings and described in the specification.

What is claimed as invention is:

1. A method of calibrating the physical location and orientation of an electronic data device in a physical space, comprising:
(a) providing an electronic data device having a core processor, permanent memory for storing a program, temporary memory for loading and running a computer-executable program, means to load a computer-executable program onto the electronic data device, an electronic visual display, a visual display subsystem, at least one user input means for interacting with a computer-executable program, a motion detection subsystem, and an orientation detection subsystem;
(b) moving the electronic data device to a physical space;
(c) loading a position and orientation calibration program with a device drawing coordinate system onto the electronic data device, wherein said program when executed by the electronic data device causes the device to visually display a two- or three-dimensional virtual representation of a physical space on the electronic visual display and a user interface for the user to initiate program commands; and
(d) initiating execution of the position and orientation calibration program such that the visual display shows a virtual representation of the physical space, the user interface, and user prompts which prompt the user to move to one or more locations in the physical space to electronically set and define at least one calibration point;
(e) marking at least one calibration point in the displayed virtual representation of the physical space;
wherein after step (e) is completed, the position and orientation calibration program initiates a motion transformation function to display on the electronic visual display a visual position indicator indicating the initial location and orientation based on the set calibration points and thereafter uses the motion transformation function, in conjunction with motion and orientation data from the device motion and orientation subsystems, to calibrate the actual physical location and orientation of the electronic data device in the physical space and to calculate and display an updated location of the electronic data device in the 2D or 3D spatial representation.

2. The method of claim 1, wherein the after the step (e) calibration points have been selected, the current location of the electronic data device within the physical space are shown on the electronic visual display with a position indicator.

3. The method of claim 2, wherein when the electronic device is physically moved, the position and orientation program will cause the electronic data device to change the position and orientation of the position indicator on the displayed representation so as to show the new location and heading direction of the electronic data device within the physical space.

4. The method of claim 1, wherein the motion detection subsystem includes at least one motion sensor.

5. The method of claim 4, wherein the motion sensor includes a pedometer, an accelerometer, magnetometer, or a combination thereof.

6. The method of claim 1, wherein the orientation detection subsystem includes at least one rotation sensor.

7. The method of claim 6, wherein the rotation sensor includes a compass, a gyroscope, a magnetometer, or any combination thereof.

8. A system, comprising:
an electronic data device having a core processor, a permanent memory for storing a computer-executable program, temporary memory for loading and running a computer-executable program, program loading means, an electronic visual display, a display subsystem, at least one user input device for interacting with an executable program, a motion detection subsystem, and an orientation detection subsystem; and
a computer-readable medium including a position and orientation calibration program having instructions that, when executed by said core processor, cause the electronic data device to visually display a two- or three-dimensional virtual representation of a user-selected physical space on the electronic visual display and to display a prompt for a user to mark initial calibration points in the displayed virtual representation of the physical space, wherein after a user marks at least one calibration point, said position and orientation calibration program causes the electronic data device to adjust and update the location and orientation of the electronic data device as it is moved within the physical space.

9. The system of claim 8, wherein said at least one user input device includes one or more of a touchscreen, a keyboard, and a voice input.

10. The system of claim 8, wherein said program loading means includes one or more of a physical or wireless network communications subsystem, CD-ROM, memory stick, and portable hard drive.

11. The system of claim 8, wherein said motion and orientation detection subsystems include one or more motion and rotation sensors.

12. The system of claim 11, wherein said motion and rotation sensors include one or more of a pedometer, an accelerometer, a compass, a gyroscope, a magnetometer, alone or in any combination.
